(19) United States
(12) Patent Application Publication
(10) Pub. No.: US 2026/0104540 A1
(43) Pub. Date: Apr. 16, 2026

(54) Method to Fabricat Fabricate a Blazed Grating Togather with Normal Binary Pattern

(71) Applicant: Applied Materials, Inc., Santa Clara, CA (US)

(72) Inventors: Lei JIANG, San Ramon, CA (US); Zefang WANG, Santa Clara, CA (US); Ludovic GODET, Sunnyvale, CA (US)

(21) Appl. No.: 18/913,292

(22) Filed: Oct. 11, 2024

Related U.S. Application Data
(60) Provisional application No. 63/590,260, filed on Oct. 13, 2023.

(51) Int. Cl. G02B 5/18; G02B 6/293

(52) U.S. Cl. CPC G02B 5/1857; G02B 5/1819; G02B 6/29305

(57) ABSTRACT

Methods of forming an optical device having different optical device structures in a single device material layer are provided. The method includes forming a patterned hardmask over a device material layer deposited on a top surface of a substrate and patterning a first region of the device material layer to form a first plurality of optical features. The method also includes depositing a dielectric layer over the patterned hardmask and selectively etching the dielectric layer and a second region of the device material layer to form a second plurality of optical features in the device material layer. The first plurality of optical features may be binary grating structures and the second plurality of optical features may be blazed grating structures.

### CROSS-REFERENCE TO RELATED APPLICATIONS

This application claims priority to United States Provisional Patent Application Serial No. 63/590,260, filed on Oct. 13, 2023, which herein is incorporated by reference.

### BACKGROUND

### Field

Embodiments of the present disclosure generally relate to optical devices for augmented, virtual, and mixed reality. More specifically, embodiments described herein relate to an optical device and a method of forming an optical device having binary and blazed grating structures.

### Description of the Related Art

An optical device may be used to manipulate the propagation of light using structures of the optical device formed on a substrate. The optical device includes an arrangement of structures with in-plane dimensions smaller than half a design wavelength of light. The structures have sub-micron critical dimensions, e.g., nanosized dimensions, to alter light propagation by manipulating photons in order to induce localized phase discontinuities (i.e., abrupt changes of phase over a distance smaller than the wavelength of light). In addition to having sub-micron critical dimensions, it is desirable for different sections of the optical device to have different structures such as binary gratings and angled or blazed grating, particularly on the same surface.

However, forming an optical device having different optical structures may be challenging. Accordingly, there is a need in the art for an optical device and a method of forming an optical device having different optical device structures.

### SUMMARY

Embodiments of the present disclosure relate to optical devices including optical device films and methods of forming the optical device films of the optical devices. Specifically, embodiments described herein provide for optical devices including blazed and binary structures on the same device material layer.

In an embodiment, a method of forming an optical device is provided. The method includes forming a patterned hardmask over a device material layer deposited on a top surface of a substrate. A first portion of the patterned hardmask exposes a first region of the device material and a second portion of the patterned hardmask exposes a second region of the device material layer. The method also includes patterning the first region of the device material layer to form a first plurality of optical features in the first region of the device material layer, depositing a dielectric layer over the patterned hardmask and the device material layer, selectively etching the dielectric layer and the device material layer to form a second plurality of optical features in the second region of the device material layer, and removing remaining portions of the dielectric layer deposited on the device material layer. The first plurality of optical features may be binary structures and the second plurality of optical features may be blazed structures.

In an embodiment, a method of forming an optical device is provided. The method includes positioning a substrate in a process chamber, the substrate comprising a device material layer deposited over a top surface of the substrate, and forming a patterned hardmask over the device material layer. A first portion of the patterned hardmask exposes a first region of the device material and a second portion of the patterned hardmask exposes a second region of the device material layer. The method also includes forming a first resist layer over the patterned hardmask, the first region of the device material layer exposed by the first resist layer, and etching the first region of the device material layer to form a first plurality of optical features in the device material layer. The method further includes depositing a dielectric layer over the first and second regions of the device material layer exposed by the patterned hardmask, depositing a second resist layer over the patterned hardmask, and patterning the dielectric layer deposited over the second region of the device material layer to form a plurality of dielectric structures over the second region of the device material layer. The second resist layer exposes the dielectric layer deposited over the second region of the device material layer. The method continues with etching the plurality of dielectric structures and the second region of the device material layer to form a second plurality of optical features in the second region of the device material layer, and removing the second resist layer and remaining portions of the dielectric layer over the first region of the device material layer.

In another embodiment, an optical device is provided. The optical device includes a substrate having a device material layer disposed thereon, and a first grating region formed in a top surface of the device material layer. The first grating region is formed on a first portion of the device material layer and comprises a plurality of binary grating structures having top surfaces substantially parallel with a top surface of the substrate, and sidewalls substantially perpendicular to the top surface of the substrate. The optical device also includes a second grating region formed in the top surface of the device material layer on a second portion of the device material layer. The second grating region comprising a plurality of blazed grating structures.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and the present disclosure may admit to other equally effective embodiments.

FIG. 1 is a perspective, frontal view of an optical device, according to certain embodiments.

FIG. 2 illustrates a schematic, cross-sectional view of an optical device, according to certain embodiments.

FIG. 3 illustrates a flow diagram of a method of forming an optical device film, according to certain embodiments.

FIGS. 4A-4K illustrate a schematic, cross-sectional view of an optical device undergoing the method of FIG. 3, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices for augmented, virtual, and mixed reality. More specifically, embodiments described herein relate to an optical device and a method of forming an optical device having different optical device structures.

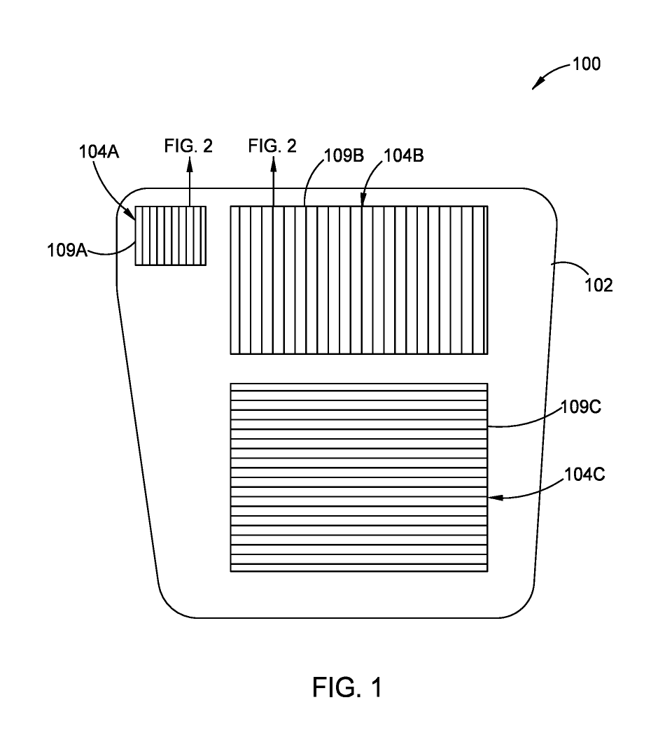

FIG. 1 is a perspective, frontal view of an optical device 100. In an embodiment, the optical device 100 is a waveguide combiner. It is to be understood that the optical device 100 described below is an exemplary waveguide combiner. The optical device 100 includes a substrate 102 having a first grating region 104A defined by a first plurality of optical device structures 109A, a second grating region 104B defined by a second plurality of optical device structures 109B, and a third grating region 104C defined by a third plurality of optical device structures 109C. In one embodiment, which can combined with other embodiments described herein, the optical device 100 includes at least the first grating region 104A corresponding to an input coupling grating region of a waveguide combiner and the third grating region 104C corresponding to an output coupling grating region of the same waveguide combiner. In other embodiments, the optical device 100 may include at least the first grating region 104A corresponding to an input coupling grating region and the second grating region 104B corresponding to an intermediate grating region.

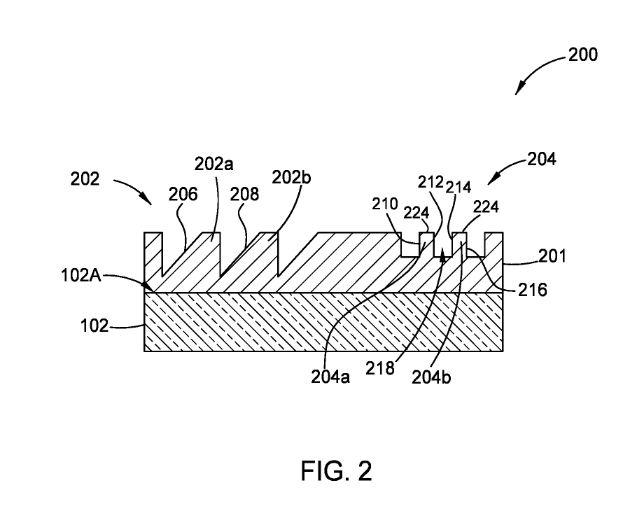

FIG. 2 is a schematic, cross-sectional view of a portion 200 of the optical device 100. The portion 200 includes a plurality of blazed grating structures 202 and a plurality of binary grating structures 204 formed in a grating material layer 201 disposed over a substrate 102. In an embodiment, the plurality of blazed grating structures 202 and the plurality of binary grating structures 204 of the portion 200 may correspond to the first and second plurality of optical device structures 109A, 109B of the first and second grating regions 104A, 104B, respectively. In the embodiment shown, the grating material layer 201 and the plurality of binary and blazed grating structures 202, 204 formed therein are disposed over a top surface 102A of the substrate 102. In another embodiment, the plurality of blazed grating structures 202 and the plurality of binary grating structures 204 of the portion 200 may be formed in the substrate 102.

The plurality of blazed grating structures 202 and the plurality of binary grating structures 204 maybe spaced apart from each other in a direction parallel with the top surface 102A of the substrate 102. In an embodiment, the blazed grating structures 202 can include a blazed surface that is angled or slanted relative to the top surface 102A of the substrate 102. For example, FIG. 2 shows a blazed surface 206 of a first blazed grating structure 202a and a blazed surface 208 of a second blazed grating structure 202b slanted relative to the top surface 102A of the substrate 102.

In an embodiment, which can be combined with other embodiments described herein, the plurality of binary grating structures 204 can be formed with top surfaces 224 parallel with the top surface 102A of the substrate 102. Furthermore, in some embodiments, the sidewalls of the plurality of binary grating structures 204 may be parallel with each other. For example, FIG. 2 shows a first sidewall 211 and a second sidewall 212 of a first binary grating structure 204a parallel with a third sidewall 214 and a fourth sidewall 216 of a second binary grating structure 204b. Additionally, the sidewalls 211, 212, 214 and 216 can be oriented normal to the top surface 102A of the substrate 102. In certain embodiments, the plurality of binary grating structures 204 can include sub-micron critical dimensions, e.g., nanosized dimensions corresponding to a width of the space 218 between each of the plurality of binary grating structures 204.

In an embodiment, the substrate 102 may be any suitable material that can adequately transmit light in a desired wavelength or wavelength range and can serve as an adequate support for the portion 200 of the optical device 100. In some embodiments, which can be combined with other embodiments described herein, the material of substrate 102 includes, but is not limited to, one or more silicon (Si), silicon dioxide (SiO₂), or sapphire containing materials. For example, the material of substrate 102, may include at least one of silicon (Si), silicon dioxide (SiO₂), silicon carbide (SiC), germanium (Ge), silicon germanium (SiGe), indium phosphide (InP), gallium arsenide (GaAs), gallium nitride (GaN), fused silica, quartz, or sapphire. In another embodiment, the material of substrate 102 includes high-index transparent materials, such as high-refractive-index (high RI) glass. In other embodiments, which can be combined with other embodiments described herein, the material of substrate 102 includes, but is not limited to, materials having a refractive index between about 1.7 and about 2.0.

In an embodiment, which can be combined with other embodiments described herein, the grating material layer 201 includes at least one of silicon oxycarbide (SiOC), titanium oxide (TiOx), TiOx nanomaterials, niobium oxide (NbOx), niobium-germanium (Nb3Ge), silicon oxycarbonitride (SiOCN), vanadium (IV) oxide (VOx), aluminum oxide (Al2O3), indium tin oxide (ITO), zinc oxide (ZnO), tantalum pentoxide (Ta2O5), silicon nitride (Si3N4), Si3N4 silicon-rich, Si3N4 hydrogen-doped Si3N4 boron-doped, silicon carbon nitrate (SiCN), titanium nitride (TiN), zirconium dioxide (ZrO2), gallium phosphide (GaP), poly-crystalline (PCD), nanocrystalline diamond (NCD), and doped diamond containing materials.

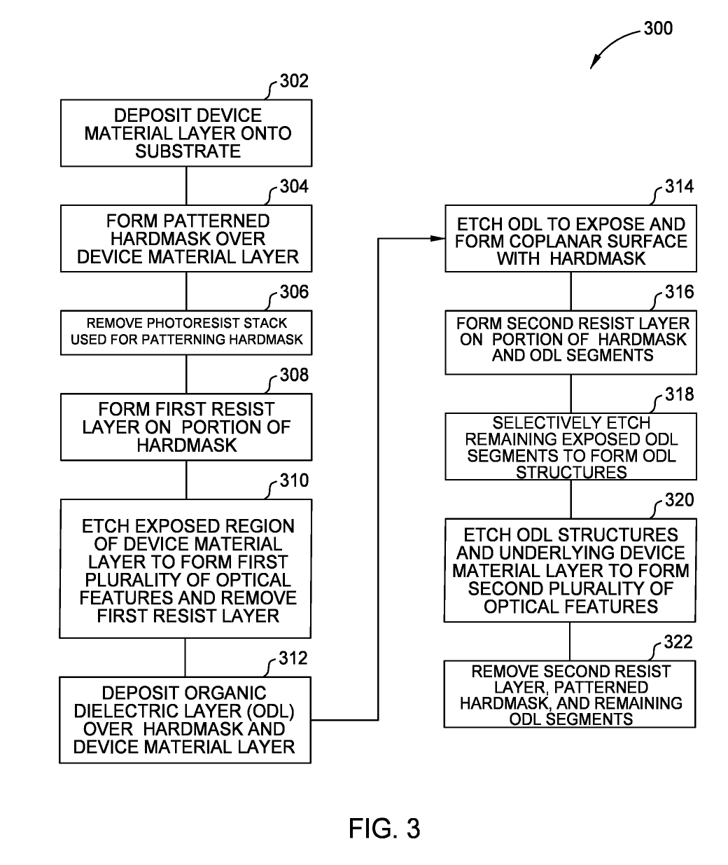

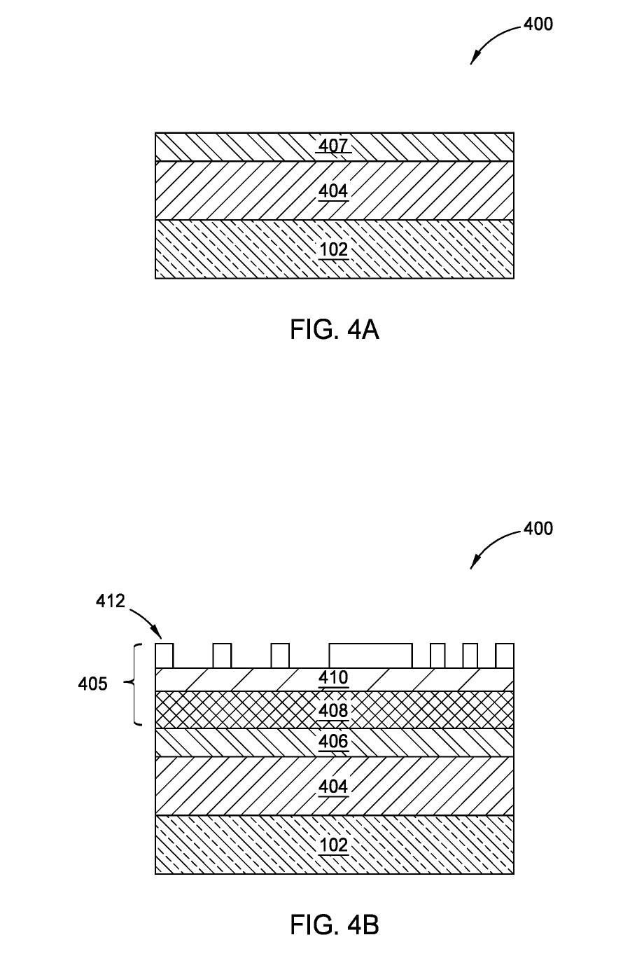

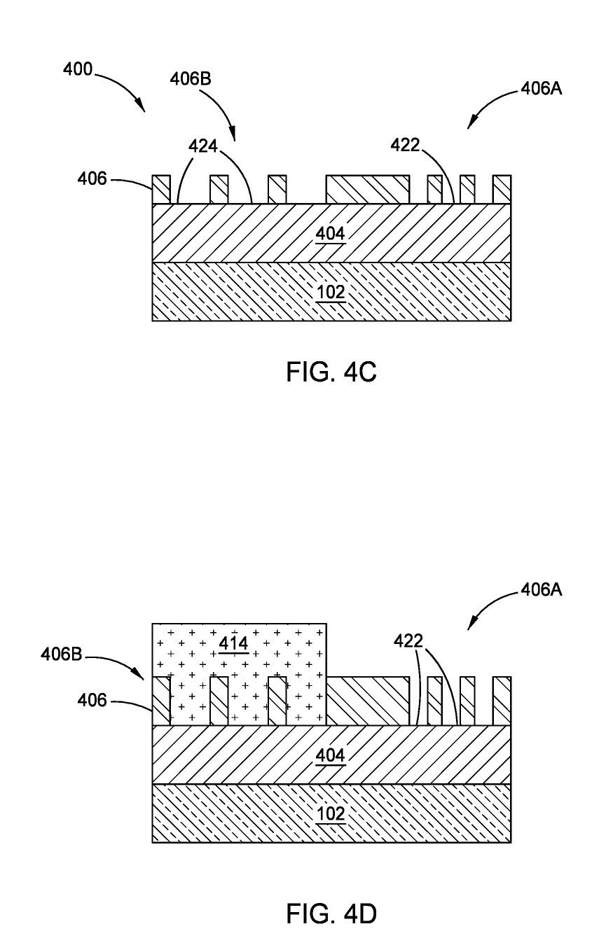

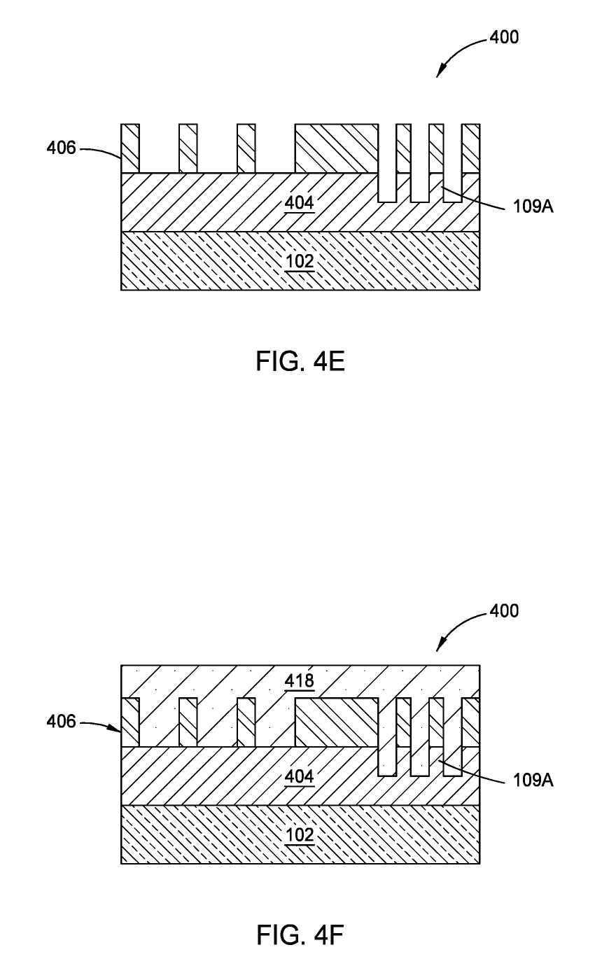

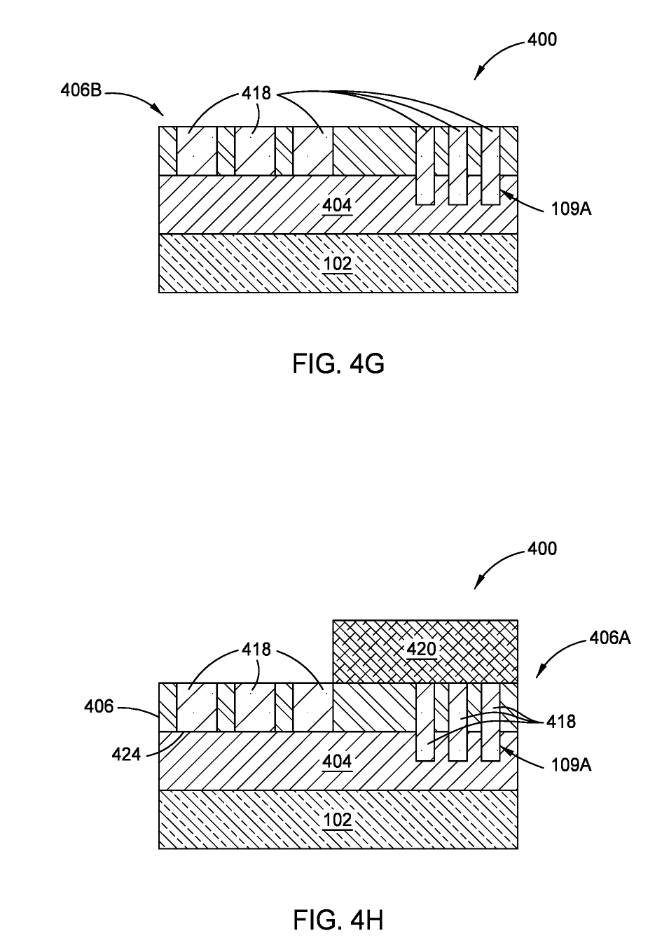

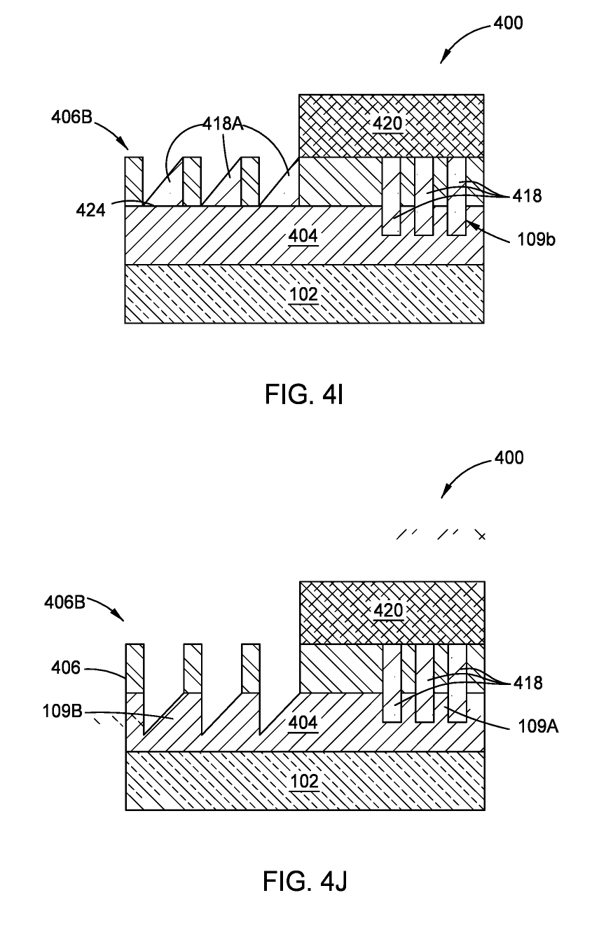

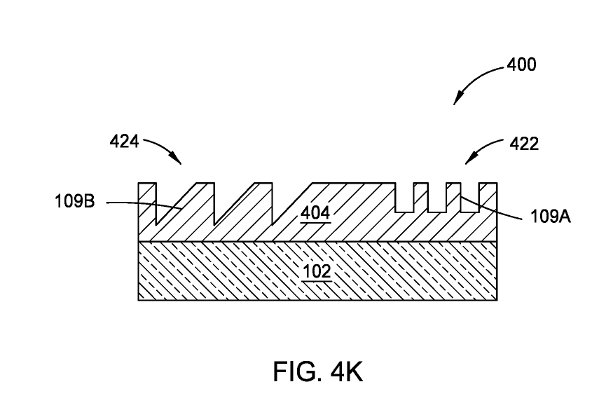

FIG. 3 is a flow diagram of a method 300 of forming a portion of the optical device 400, according to certain embodiments. FIGS. 4A-4J are schematic, cross-sectional side views of the optical device 400 during the various operations of the method 300.

At operation 302, a device material layer 404 is disposed over a surface of a substrate 102. The device material layer 404 may be a single layer or may be a matrix stack including multiple layers. The device material layer 404 may be of any of the materials described above with respect to the grating material layer 201. For example, the device material layer 404 may include at least one of silicon (Si), silicon dioxide (SiO₂), silicon carbide (SiC), germanium (Ge), silicon germanium (SiGe), indium phosphide (InP), gallium arsenide (GaAs), gallium nitride (GaN), fused silica, quartz, or sapphire.

The device material layer 404 may be disposed over the surface of the substrate 302 by one or more (PVD), chemical vapor deposition (CVD), plasma-enhanced (PECVD), flowable CVD (FCVD), atomic layer deposition (ALD), or spin-on processes. In one embodiment, which can be combined with other embodiments described herein, the device material of device material layer 404 is selected based on the modulated depth and slant angle of the optical structures to be formed for of the portion 200 of optical device 100 and the refractive index of the substrate 102. In some embodiments, which can be combined with other embodiments described herein, the device material layer 404 includes, but is not limited to, one or more silicon nitride (SiN), silicon oxycarbide (SiOC), titanium oxide (TiOx), titanium dioxide (TiO2), silicon dioxide (SiO2), vanadium (IV) oxide (VOx), aluminum oxide (Al2O3), indium tin oxide (ITO), zinc oxide (ZnO), tantalum pentoxide (Ta2O5), silicon nitride (Si3N4), zirconium dioxide (ZrO2), or silicon carbon-nitride (SiCN) containing materials. In some embodiments, which can be combined with other embodiments described herein, the device material of the device material layer 404 may have a refractive index between about 1.5 and about 2.65. In other embodiments, which can be combined with other embodiments described herein, the device material of the device material layer 404 may have a refractive index between about 3.5 and about 4.0.

At operation 304, a patterned hardmask 406 is formed over the device material layer 404. In an embodiment, the patterned hardmask 406 may be made of any suitable material for patterning the device material layer 404 using a lithography process, such as chromium or silicon nitride. In one embodiment, which can be combined with other embodiments described herein, the patterned hardmask 406 is non-transparent and is removed after the portion 200 of optical device 100 is formed. In another embodiment, the patterned hardmask 406 is transparent. In some embodiments, which can be combined with other embodiments described herein, the hardmask 312 includes, but is not limited to, chromium (Cr), silver (Ag), Si3N4, SiO2, TiN, or carbon (C) containing materials. In certain embodiments, forming the patterned hardmask 406 in operation 304 includes disposing a hardmask material layer 407 over the device material layer 404, disposing a photoresist layer over the hardmask material layer 407, patterning the photoresist layer to expose portions of the hardmask material layer 407, and removing the exposed portions of the hardmask material layer 407 to form the patterned hardmask 406 with hardmask structures 406A patterned therein.

The hardmask material layer 407 may be disposed over the device material layer 404 by one or more liquid material pour casting, spin-on coating, liquid spray coating, dry powder coating, screen printing, doctor blading, PVD, CVD, PECVD, FCVD, ALD, evaporation, or sputtering processes. The hardmask 312 can be deposited so that the thickness of the hardmask 312 is substantially uniform. In yet other embodiments, the hardmask 312 can be deposited so that the thickness varies from about 30 nm and about 50 nm at varying points on the device material layer 404.

In an embodiment, as shown in FIG. 4B, operation 304 may include depositing a photoresist stack 405 over the hardmask material layer 407. In an embodiment, the photoresist stack 405 includes an organic planarizing layer (OPL) 408, a silicon-containing anti-reflective coating (SiARC) 410, and a patterned photoresist layer 412. In an embodiment, The OPL 408 may include any organic polymer and a photo-active compound having a molecular structure that can attach to the molecular structure of the organic polymer. For example, the OPL 408 may include a photo-sensitive organic polymer comprising a light-sensitive material that, when exposed to electromagnetic (EM) radiation, is chemically altered and thus configured to be removed using a developing solvent. In one embodiment, which can be combined with other embodiments described herein, the OPL 408 may be disposed using a spin-on coating process. In another embodiment, which can be combined with other embodiments described herein, the OPL 408 may include, but is not limited to, one or more of polyacrylate resin, epoxy resin, phenol resin, polyamide resin, polyimide resin, unsaturated polyester resin, polyphenylenether resin, polyphenylenesulfide resin, or benzocyclobutene (BCB). Next, the SiARC 410 is formed over the OPL 408. In an embodiment, the SiARC 410 is formed from silicon-based materials using, for example, a chemical vapor deposition process or a spin coating process.

Lastly, the patterned photoresist layer 412 is formed by disposing a photoresist material on the SiARC 410 and developing the photoresist material. The patterned photoresist layer 412 defines a hardmask pattern for patterning the hardmask material layer 407. In one embodiment, which can be combined with other embodiments described herein, the photoresist material may be disposed on the OPL 408 using a spin-on coating process. In another embodiment, which can be combined with other embodiments described herein, the patterned photoresist layer 412 may include, but is not limited to, light-sensitive polymer containing materials. In an embodiment, the patterned photoresist layer 412 may comprise a polymer material, such as polydimethylsiloxane (PDMS). In an embodiment, the patterned photoresist layer 412 may include a solvent, a photoresist resin, and a photoacid generator. The photoresist resin may be any positive photoresist resin or any negative photoresist resin. Representative photoresist resins include acrylates, novolak resins, poly(methylmethacrylates), and poly(olefin sulfones. Developing the photoresist material may include performing a lithography process, such as photolithography and/or digital lithography.

As discussed above, the patterned photoresist layer 412 defines the hardmask pattern for patterning the hardmask material layer 407 using the photoresist stack 405. After the patterned photoresist layer 412 is formed, the photoresist stack 405 and the hardmask material layer 407 are patterned using an etching process. It should be understood that patterning the hardmask material layer 407 with OPL 408 and SiARC 410 is an exemplary method. Other patterning methods can be used together. In certain embodiments, the patterning method is generally selected with regard to the size and shape of the structure to be patterned.

In operation 306, the photoresist stack 405 is removed using suitable methods, such as resist stripping. Stripping the patterned photoresist layer 412, SiARC 410, and OPL 408 yields the patterned hardmask 406. The patterned hardmask 406 includes a first portion 406A and a second portion 406B. The pattern in the first portion 406A exposes a first region 422 of the device material layer 404 below, and the pattern in the second portion 406B exposes a second region 424 of the device material layer 404.

In operation 308, a first resist layer 414 is formed over the second portion 406B of the patterned hardmask 406 and the second region 424 of the device material layer 404, as shown in FIG. 4D. The first resist layer 414 prevents the second region 424 of the device material layer 404 from being impacted by one or more etch process in subsequent operation 310. Although non-limiting, the first resist layer 414 maybe a photoresist film or a gray tone resist film. Alternatively, the first resist layer 414 may be a hardmask, such as a Cr hardmask deposited as a thin film and lithographically patterned.

In operation 310, the first region 422 of the device material layer 404 exposed by the first portion 406A of the patterned hardmask 406 is etched to pattern the first region 422 of the device material layer 404 and form the plurality of optical device structures 109A in the device material layer 404, as shown in FIG. 4E. In an embodiment, the plurality of optical device structures 109A formed in operation 310 includes a plurality of binary optical features, such as the plurality of binary grating structures 204 discussed above for FIG. 2. After the plurality of optical device structures 109A are formed, the first resist layer 414 is removed from the patterned hardmask 406.

In operation 312, an organic dielectric layer (ODL) 418 is deposited over the patterned hardmask 406 and the first and second regions 422, 424 of the device material layer 404 exposed by the patterned hardmask 406. For example, the ODL 418 may be deposited by a vapor deposition process, such as by fluorinated chemical vapor deposition over the patterned hardmask 406, the second region 424 of the device material layer 404, and the first region 422 of the device material layer 404 including the spaces between the plurality optical device structures 109A formed in the first region 422 of the device material layer 404.

In operation 314, the ODL 418 may be etched, for example by blanket etching, to remove excess portions of the ODL 418 and expose the patterned hardmask 406. Operation 314 results in forming a planar surface across a top surface of the patterned hardmask 406 and the ODL 418, as shown in FIG. 4G.

In operation 316, a second resist layer 420 is formed on the first portion 406A of the patterned hardmask 406 and exposed segments of the ODL 418 deposited over the first region 422 of the device material layer 404, as shown in FIG. 4H. Operation 316 includes leaving the second portion 406B of the patterned hardmask 406 and exposed segments of the ODL 418 deposited over the second region 424 of the device material layer 404 exposed. In contrast, the second resist layer 420 prevents segments of the ODL 418 exposed by the first portion 406A of the patterned hardmask 406 from being impacted by one or more etch process in subsequent operation 318. Although non-limiting, the second resist layer 420 maybe a photoresist film or a gray tone resist film. Alternatively, the second resist layer 420 may be a hardmask, such as a Cr hardmask deposited as a thin film and lithographically patterned.

In operation 318, the exposed segments of the ODL 418 over the second region 424 of the device material layer 404 is selectively etched to form dielectric structures in the exposed ODL 418 segments. For example, operation 318 may include directionally etching the exposed segments of the ODL 418 to produce a plurality of blazed ODL structures 418A within the openings in the second portion 406B of the patterned hardmask 406, as shown in FIG. 4I. In an embodiment, operation 318 may be performed by a selective etch process. The selective etch process may include, but is not limited to, at least one of IBE, RIE, or directional RIE. In an embodiment in which the ODL 418 is etched by an IBE process, the ion beam generated by IBE may include, but is not limited to, at least one of a ribbon beam, a spot beam, or a full substrate-size beam. The ion beam has etch chemistry that is selective to the patterned hardmask 306, i.e., only exposed segments of the ODL 418 is etched. Performing the selective etch process etches the exposed segments of the ODL 418 to form the plurality of blazed ODL structures 418A.

In operation 320, a transfer etch process is performed on the plurality of blazed ODL structures 418A of the ODL 418 to form the second plurality of optical device structures 109B in the underlying device material layer 404. The results of operation 320 are shown in FIG. 4J. In this embodiment, the transfer etch process removes the blazed ODL structures 418 and etches the device mater layer 404 to produce the second plurality of optical device structures 109B within the second region 424 of the device material layer 404. In an embodiment, the transfer etch process in operation 320 may be the same etch process utilized in operation 318, such as an IBE process.

In operation 322, the second resist layer 420, segments of the ODL 418 deposited over the first region 422 of the device material layer 404, and the patterned hardmask 406 may be removed, such as by resist stripping and wet etching. Removing the second photoresist layer 420, the ODL 418, and the patterned hardmask 406 results in the portion of optical device 400, as shown in FIG. 4K. In an embodiment, the the portion of optical device 400 formed from method 300 may correspond to the portion 200 of the optical device 100 having the plurality of blazed grating structures 202 and the plurality of binary grating structures 204 formed in the grating material layer 201. In some embodiments, the patterned hardmask 406 may be made of a transparent material such that the patterned hardmask 406 is left on the device material layer 404.

In summation, the methods for forming an optical device having blazed and binary grating structures on the same device material layer are described herein. The methods include forming binary grating structures in a first region of the device material layer and forming blazed grating structures in a second region of the device material layer. The blazed grating structures may be formed using a selective etch process, such as IBE, and the binary grating structures may be formed using a single lithography process. The methods described herein may advantageously provide for easily forming different optical structures in a device material layer to improve optical performance of an optical device. For example, the methods provide for forming blazed grating structures that can be used grating structures for an input coupling region in a waveguide combiner. Blazed grating structures are desirable for input coupling regions of AR waveguide combiners due to the high diffraction efficiency of the blazed grating structures. The method described herein can also be used to create a device structure that functions as a master for nanoimprint lithography.

When introducing elements of the present disclosure or exemplary aspects or embodiment(s) thereof, the articles “a,” “an,” “the” and “said” are intended to mean that there are one or more of the elements.

The terms “comprising,” “including” and “having” are intended to be inclusive and mean that there may be additional elements other than the listed elements.

The term “coupled” is used herein to refer to the direct or indirect coupling between two objects. For example, if object A physically touches object B and object B touches object C, the objects A and C may still be considered coupled to one another—even if objects A and C do not directly physically touch each other. For instance, a fist object may be coupled to a second object even though the first object is never directly in physical contact with the second object.

While the foregoing is directed to embodiments of the present disclosure, other and further embodiments of the disclosure may be devised without departing from the basic scope thereof, and the scope thereof is determined by the claims that follow.

What is claimed is:

1. A method of forming an optical device, comprising:
forming a patterned hardmask over a device material layer deposited on a top surface of a substrate, a first portion of the patterned hardmask exposing a first region of the device material and a second portion of the patterned hardmask exposing a second region of the device material layer;
patterning the first region of the device material layer to form a first plurality of optical features in the first region of the device material layer,
depositing a dielectric layer over the patterned hardmask and the device material layer;
selectively etching the dielectric layer and the device material layer to form a second plurality of optical features in the second region of the device material layer; and
removing remaining portions of the dielectric layer deposited on the device material layer.

2. The method of claim 1, wherein the first plurality of optical features comprises a plurality of binary grating structures having top surfaces substantially parallel with the top surface of the substrate, and sidewalls substantially perpendicular to the top surface of the substrate.

3. The method of claim 1, wherein the second plurality of optical features comprises a plurality of blazed grating structures.

4. The method of claim 1, wherein patterning the first region of the device material layer to form the first plurality of optical features comprises performing a lithographic patterning and etch process in the first region of the device material layer.

5. The method of claim 1, wherein selectively etching the dielectric layer and the device material layer comprises directionally etching the dielectric layer deposited on the second region of the device material layer exposed by the second portion of the patterned hardmask to form a plurality of dielectric structures over the second region of the device material layer, and etching the plurality of dielectric structures and the second region of the device material layer to form the second plurality of optical features in the device material layer.

6. The method of claim 1, wherein forming the patterned hardmask comprises depositing a hardmask material layer on the device material layer and performing a nanoimprint lithography process to pattern the hardmask material layer and form the patterned hardmask.

7. The method of claim 1, wherein forming the patterned hardmask comprises: depositing a hardmask material layer on the device material layer; forming a photoresist stack over the hardmask material layer, the photoresist stack comprising an organic planarizing layer (OPL), a silicon anti-reflective coating (SiARC), and a photoresist; and etching the photoresist stack to form a pattern in the hardmask material layer.

8. The method of claim 1, further comprising removing the patterned hardmask after the second plurality of optical feature are formed in the device material layer.

9. The method of claim 1, wherein selectively etching the dielectric layer and the device material layer comprises selectively etching the dielectric layer to from a plurality of dielectric structures over the second region of the device material layer, and performing a transfer etch process to etch the plurality of dielectric structures and the second region of the device material layer to form the second plurality of optical features in the second region of the device material layer.

10. A method of forming an optical device, comprising:
positioning a substrate in a process chamber, the substrate comprising a device material layer deposited over a top surface of the substrate;
forming a patterned hardmask over the device material layer, a first portion of the patterned hardmask exposing a first region of the device material and a second portion of the patterned hardmask exposing a second region of the device material layer;
forming a first resist layer over the patterned hardmask, wherein the first resist layer prevents the second region of the device material from being etched;
etching the first region of the device material layer to form a first plurality of optical features in the device material layer;
depositing a dielectric layer over the first and second regions of the device material layer exposed by the patterned hardmask;
forming a second resist layer over the patterned hardmask, wherein the second resist layer prevents segments of the dielectric layer deposited over the first region of the device material from being etched;
selectively etching segments of the dielectric layer exposed by the second portion of the patterned hardmask to form a plurality of dielectric structures over the second region of the device material layer;
etching the plurality of dielectric structures and the second region of the device material layer to form a second plurality of optical features in the second region of the device material layer;
removing the second resist layer and remaining portions of the dielectric layer over the first region of the device material layer.

11. The method of claim 10, wherein depositing the dielectric layer over the first and second regions of the device material layer comprises depositing the dielectric layer over the patterned hardmask and etching the dielectric layer to expose the patterned hardmask and form a planar surface across a top surface of the dielectric layer and a top surface of the patterned hardmask.

12. The method of claim 10, wherein the first plurality of optical features comprises a plurality of binary grating structures in which top surfaces of the plurality of binary grating structures are substantially parallel with the top surface of the substrate and sidewalls of the plurality of binary grating structures are substantially perpendicular to the top surface of the substrate.

13. The method of claim 10, wherein the second plurality of optical features comprises a plurality of blazed grating structures.

14. The method of claim 10, further comprising removing the first resist layer after the first plurality of optical features are formed, and removing the second resist layer after the second plurality of optical features are formed.

15. The method of claim 10, further comprising removing the patterned hardmask after removing the remaining portions of the dielectric layer over the first region of the device material layer.

16. The method of claim 10, wherein forming the patterned hardmask comprises:
depositing a hardmask material layer on the device material layer;
forming a photoresist stack over the hardmask material layer, the photoresist stack comprising an organic planarizing layer (OPL), a silicon anti-rfeflective coating (SiARC), and a photoresist; and
etching the photoresist stack to form a pattern in the hardmask material layer.

17. An optical device, comprising:
a substrate having a device material layer disposed thereon;
a first grating region formed in a top surface of the device material layer, the first grating region on a first portion of the device material layer and comprising a plurality of binary grating structures having top surfaces substantially parallel with a top surface of the substrate, and sidewalls substantially perpendicular to the top surface of the substrate; and
a second grating region formed in the top surface of the device material layer on a second portion of the device material layer, the second grating region comprising a plurality of blazed grating structures.

18. The optical device of claim 17, wherein the first and second gratings regions correspond to an input coupling grating and an output coupling grating of a waveguide combiner, respectively.

19. The optical device of claim 17, wherein the plurality of blazed grating structures comprise a blazed surface that is angled relative to the top surface of the substrate.

20. The optical device of claim 17, further comprising a patterned hardmask disposed over the device material layer, the patterned hardmask comprising a transparent material.
